(19) United States
(12) Patent Application Publication
(10) Pub. No.: US 2005/0083460 A1
(43) Pub. Date: Apr. 21, 2005

(54) Semi-transmitting mirror-possessing substrate, and semi-transmitting type liquid crystal display apparatus

(75) Inventors: Kenji Hattori, Chiba (JP); Etsuo Ogino, Ibaraki (JP)

Correspondence Address: COHEN, PONTANI, LIEBERMAN & PAVANE, Suite 1210, 551 Fifth Avenue, New York, NY, 10176, US

(73) Assignee: Nippon Sheet Glass Co., Ltd., Osaka (JP)

(21) Appl. No.: 10/759,398

(22) Filed: Jan. 16, 2004

Related U.S. Application Data
(63) Continuation of application No. PCT/JP02/07180, filed on Jul. 15, 2002.

(30) Foreign Application Priority Data
Jul. 16, 2001 (JP) 2001-215596

(51) Int. Cl. G02F 1/1335

(52) U.S. Cl. 349/114

(57) ABSTRACT

There is provided a semi-transmitting mirror-possessing substrate that has high reflectivity while maintaining high transmissivity, whereby transmission display performance and reflection display performance can both be improved. The semi-transmitting mirror-possessing substrate 1 has a transparent glass substrate 2 made of a soda lime silicate glass, a foundation film 3 made of silicon oxide (SiOₓ) formed on the glass substrate 2, a semi-transmitting reflective film 4 made of aluminum (Al) formed on the foundation film 3, and a protective film 5 made of silicon dioxide (SiO₂) formed on the semi-transmitting reflective film 4. The film thickness of the SiOₓ used as the foundation film 3 is in a range of 0 to 8 nm. Moreover, the chemical composition ratio x of oxygen (O) to silicon (Si) in the SiOₓ is in a range of 1.5 to 2.0.

### TECHNICAL FIELD

The present invention relates to a semi-transmitting mirror-possessing substrate and a semi-transmitting type liquid crystal display apparatus, and in particular to a semi-transmitting mirror-possessing substrate and a semi-transmitting type liquid crystal display apparatus that have both high transmissivity and high reflectivity.

### BACKGROUND ART

With conventional semi-transmitting type liquid crystal display apparatuses, a semi-transmitting mirror-possessing substrate in which is formed a semi-transmitting mirror having optical properties required for carrying out display in both reflection mode and transmission mode has been used. The semi-transmitting mirror-possessing substrate is required to have high reflection performance and high transmission performance to secure good display quality (particularly brightness) in both reflection mode and transmission mode.

Such a semi-transmitting mirror-possessing substrate has a glass substrate, a silicon oxide (SiO₂) film formed as a foundation film on the glass substrate, an Al film or an Al alloy film made of Al—Ti, Al—Nd or the like formed as a semi-transmitting reflective film on the SiO₂ film, and an SiO₂ film formed as a protective film on the Al film or Al alloy film. The foundation film, the semi-transmitting reflective film, and the protective film constitute a semi-transmitting mirror, and the semi-transmitting mirror has a function of reflecting light. The reflection performance and the transmission performance of the semi-transmitting mirror are controlled through the thickness of the Al film or the like that constitutes the semi-transmitting reflective film.

The transmissivity of the semi-transmitting reflective film is generally set to be in a range of 15 to 20%. On the other hand, regarding the reflectivity, optical absorption characteristic of metals occurs, and hence the reflectivity is determined by the amount of light obtained by subtracting the amount of transmitted light and the amount of absorbed light from the total amount of light. For the display performance of a semi-transmitting type liquid crystal display apparatus in which a semi-transmitting mirror-possessing substrate is used, in general the minimum quality required is that the semi-transmitting mirror has a transmissivity of at least 20% and a reflectivity of at least 60%.

As means for manufacturing a semi-transmitting mirror, there are a vacuum deposition method and a sputtering method, but from the perspective of durability, the sputtering method is predominantly used.

However, with a conventional semi-transmitting mirror-possessing substrate, there is a problem that if the transmissivity of the semi-transmitting mirror is made high, then sufficient reflectivity cannot be obtained. In particular, in the case that a high transmissivity of 15% or more is obtained, the drop in the reflectivity is marked. It is thought that this is because the amount of optical absorption of the semi-transmitting mirror increases, resulting in a drop in the reflection strength. That is, to increase the transmissivity, the semi-transmitting reflective film made of Al or the like is made thinner, and it is thought that as a result the original bulk structure of the Al metal changes to a different structure due to disturbance of the crystal lattice of the Al metal, and hence the amount of optical absorption of the semi-transmitting reflective film increases.

It is an object of the present invention to provide a semi-transmitting mirror-possessing substrate and a semi-transmitting type liquid crystal display apparatus, according to which there is high reflectivity while maintaining high transmissivity, and hence both the transmission display performance and the reflection display performance can be improved.

### DISCLOSURE OF THE INVENTION

To attain the above object, according to a first aspect of the present invention, there is provided a semi-transmitting mirror-possessing substrate having a substrate, a foundation film formed on the substrate, and a semi-transmitting reflective film formed on the foundation film, the semi-transmitting mirror-possessing substrate characterized in that the foundation film has a thickness in a range of 0 to 8 nm.

Moreover, in the semi-transmitting mirror-possessing substrate according to the first aspect, the foundation film is preferably made of silicon oxide.

Moreover, in the semi-transmitting mirror-possessing substrate according to the first aspect, the chemical composition ratio x of oxygen (O) to silicon (Si) in the silicon oxide (SiOₓ) is preferably in a range of 1.5 to 2.0.

Furthermore, in the semi-transmitting mirror-possessing substrate according to the first aspect, the semi-transmitting reflective film is preferably made of at least one selected from the group consisting of Al and Al alloys.

To attain the above object, according to a second aspect of the present invention, there is provided a semi-transmitting type liquid crystal display apparatus characterized by having the semi-transmitting mirror-possessing substrate according to the first aspect of the present invention.

### BRIEF DESCRIPTION OF THE DRAWINGS

FIG. 1 is a sectional view showing schematically the structure of a semi-transmitting mirror-possessing substrate according to an embodiment of the present invention;

FIG. 2 is a sectional view showing schematically the structure of an example of a semi-transmitting type liquid crystal display apparatus manufactured using the semi-transmitting mirror-possessing substrate shown in FIG. 1;

FIG. 3 is a graph showing optical properties for Examples 1 and 2 shown in Table 1;

FIG. 4 is a graph showing optical properties for Examples 3 to 6 and Comparative Example 1 shown in Table 1;

FIG. 5 is a graph showing optical properties for Examples 7 to 10 and Comparative Example 2 shown in Table 1;

FIG. 6 is a graph showing optical properties for Examples 11 to 14 and Comparative Example 3 shown in Table 1;

FIG. 7 is a graph showing the relationship between the Ar/O₂ mixed gas flow rate ratio and the x value for the foundation film for Examples 15 to 22 shown in Table 2; and

FIG. 8 is a graph showing the relationship between the x value for the foundation film and optical properties for Examples 23 to 27 and Comparative Examples 4 to 6 shown in Table 3.

### BEST MODES FOR CARRYING OUT THE INVENTION

The present inventors carried out assiduous studies to attain the above object, and as a result discovered that in the case of a semi-transmitting mirror-possessing substrate having a substrate, a foundation film formed on the substrate, and a semi-transmitting reflective film formed on the foundation film, if the thickness of the foundation film is in a range of 0 to 8 nm, then reflectivity can be increased while maintaining high transmissivity, and hence both the transmission display performance and the reflection display performance can be improved.

Moreover, the present inventors discovered that if the foundation film is made of silicon oxide (SiOₓ), and the chemical composition ratio x of oxygen (O) to silicon (Si) in the SiOₓ is in a range of 1.5 to 2.0, then the reflectivity can be increased while maintaining high transmissivity, and hence both the transmission display performance and the reflection display performance can be further improved.

Embodiments of the present invention will now be described in detail with reference to the drawings.

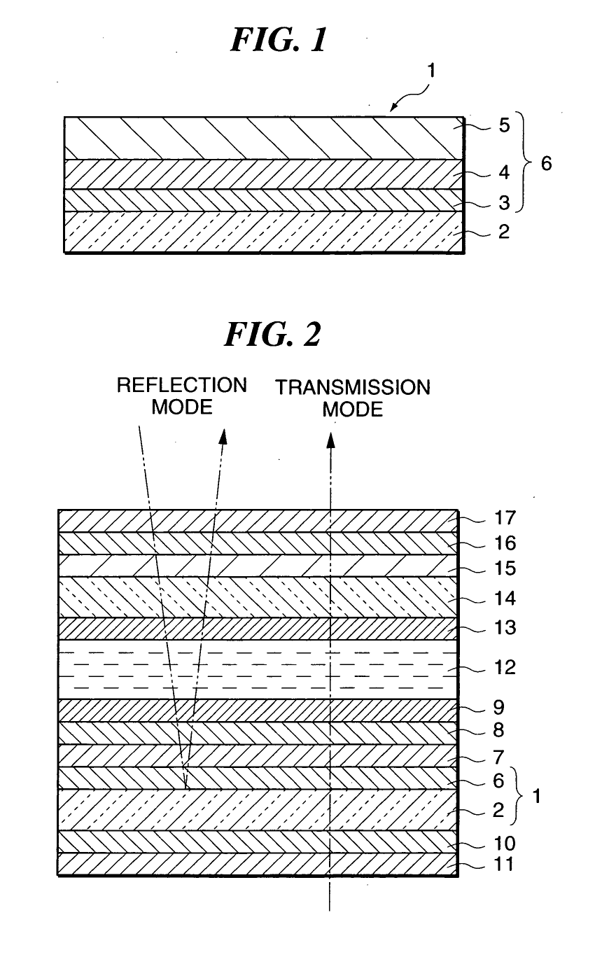

FIG. 1 is a sectional view showing schematically the structure of a semi-transmitting mirror-possessing substrate according to an embodiment of the present invention.

In FIG. 1, the semi-transmitting mirror-possessing substrate 1 has a transparent glass substrate 2, a foundation film 3 made of silicon oxide (SiOₓ) formed on the glass substrate 2, a semi-transmitting reflective film 4 made of aluminum (Al) formed on the foundation film 3, and a protective film 5 made of silicon dioxide (SiO₂) formed on the semi-transmitting reflective film 4. The foundation film 3, the semi-transmitting reflective film 4 and the protective film 5 are formed in this order on the glass substrate 2. The foundation film 3, the semi-transmitting reflective film 4 and the protective film 5 constitute a semi-transmitting mirror 6, and the semi-transmitting mirror 6 has a function of reflecting light.

For the glass substrate 2, a soda lime silicate glass, a low-alkali glass or an alkali-free glass having a refractive index in a range of approximately 1.50 to 1.55 at a wavelength of 550 nm is preferable, but there is no limitation thereto; a transparent resin such as a plastic may be used instead.

The semi-transmitting reflective film 4 in the semi-transmitting mirror 6 is here comprised of a thin metal film made of Al that is made sufficiently thin so as to partially transmit light, but there is no limitation thereto; an Al alloy such as Al—Ti or Al—Nd may be used instead. The protective film 5 is formed on the semi-transmitting reflective film 4 to mechanically protect the semi-transmitting reflective film 4 and secure good chemical resistance and water resistance, and also to secure good adhesion to CF (color filters) formed on the protective film 5 in a semi-transmitting type liquid crystal display apparatus as shown in FIG. 2, described later.

The thickness of the foundation film 3 made of SiOₓ is made to be in a range of 0 to 8 nm. This is because if the thickness of the foundation film 3 exceeds 8 nm, then the reflectivity of the semi-transmitting mirror 6 will drop, and moreover the amount of optical absorption of the Al metal itself will increase. A more preferable range for the thickness of the foundation film 3 is 3 to 6 nm. The foundation film 3 originally has functions of preventing diffusion of an alkali leaching out from the inside of the glass substrate 2 (alkali passivation), and improving adhesion between the glass substrate 2 and the reflective film 4, but through the thickness of the foundation film 3 being in a range of 0 to 8 nm, the crystal structure of the Al metal in the semi-transmitting reflective film 4 formed on the foundation film 3 can also be improved, and hence an increase in the amount of optical absorption of the Al metal itself can be prevented, and thus the optical transmission performance and reflection performance can both be improved.

Furthermore, to improve the transmission performance and the reflection performance of the semi-transmitting mirror 6, the chemical composition ratio x of oxygen (O) to silicon (Si) in the SiOₓ used as the foundation film 3 is made to be in a range of 1.5 to 2.0. Through the chemical composition ratio x of O to Si in the SiOₓ being in a range of 1.5 to 2.0, the crystal structure of the Al metal in the semi-transmitting reflective film 4 formed on the SiOₓ can be improved, and hence an increase in the amount of optical absorption of the Al metal itself can be prevented, and thus the optical transmission performance and reflection performance can both be improved.

A reflection-increasing laminate in which layer(s) made of a low-refractive-index material and layer(s) made of a high-refractive-index material are formed alternately may be formed on the semi-transmitting reflective film 4 instead of the protective film 5. There are no particular limitations on the number of layers in the laminate, but considering the reflection performance and the cost, this number is generally preferably in a range of 2 to 5. Silicon oxide or magnesium fluoride is generally used as the low-refractive-index material, and titanium oxide, tantalum oxide or niobium oxide is generally used as the high-refractive-index material. Such a reflection-increasing laminate does not bring about optical absorption, and hence can be suitably used as a semi-transmitting film.

As the method of forming the foundation film 3 and the protective film 5, in general a known vacuum deposition method, ion plating method or sputtering method is used, but so long as the thickness of the foundation film 3 can be precisely controlled, another method may be used. In particular, it is preferable to form the foundation film 3 by direct current sputtering using an Ar/O₂ mixed gas with electrically conductive (B-doped) Si as a target material. Moreover, it is preferable to form the semi-transmitting reflective film 4 by direct current sputtering using Ar gas with high-purity Al as a target material.

According to the semi-transmitting mirror-possessing substrate 1 shown in FIG. 1, the thickness of the foundation film 3 made of SiOₓ is set to be in a range of 0 to 8 nm, and the chemical composition ratio x of O to Si in the SiOₓ is set to be in a range of 1.5 to 2.0, whereby the semi-transmitting mirror-possessing substrate 1 has high reflectivity while maintaining high transmissivity, and hence the transmission performance and the reflection performance can both be improved.

FIG. 2 is a sectional view showing schematically the structure of an example of a semi-transmitting type liquid crystal display apparatus manufactured using the semi-transmitting mirror-possessing substrate 1 shown in FIG. 1.

In FIG. 2, color filters 7 arranged in mosaic fashion are formed on the semi-transmitting mirror 6, and an overcoat 8 for protecting the color filters 7, and a transparent conductive film 9 made of ITO (indium thin oxide) are formed thereon in this order. Moreover, a phase contrast plate 10 and a polarizing plate 11 are formed in this order on the outside of the glass substrate 2. A liquid crystal layer 12 is interposed between the transparent conductive film 9 and a transparent conductive film 13, which is formed on the inside of a front glass plate 14. A diffusing plate 15, a phase contrast plate 16, and a polarizing plate 17 are formed in this order on the outside of the front glass plate 14.

According to the above construction, display can be carried out in both reflection mode and transmission mode.

According to the semi-transmitting type liquid crystal display apparatus shown in FIG. 2, the transmission display performance and the reflection display performance can be improved; as a result the efficiency of utilization of light is improved, and hence the brightness of a backlight, not shown in the drawings, can be kept down, and thus there is an effect of reducing the power consumption of the semi-transmitting type liquid crystal display apparatus.

Next, concrete examples of the present invention will be described.

First, a glass substrate 2 made of a soda lime silicate glass having a thickness of 0.5 mm and having polished main surfaces was prepared, and a foundation film 3, a semi-transmitting reflective film 4, and a protective film 5 were formed in this order on the glass substrate 2 by sputtering, thus forming a semi-transmitting mirror-possessing substrate 1.

Specifically, a foundation film 3 made of SiOₓ was formed on the glass substrate 2 to a predetermined thickness (0, 3, 5, 8, or 12 nm) by direct current sputtering using an Ar/O₂ mixed gas with electrically conductive (B-doped) Si as a target material, then a semi-transmitting reflective film 4 made of Al was formed on the foundation film 3 to a predetermined thickness (7.5, 9, 11, or 13 nm) by direct current sputtering using Ar gas with high-purity Al (5N) as a target material, and then a protective film 5 made of SiO₂ was formed on the semi-transmitting reflective film 4 to a predetermined thickness (25 nm) using a similar method to that used for the foundation film 3, whereby samples (Examples 1 to 14, and Comparative Examples 1 to 3) were prepared as shown in Table 1.

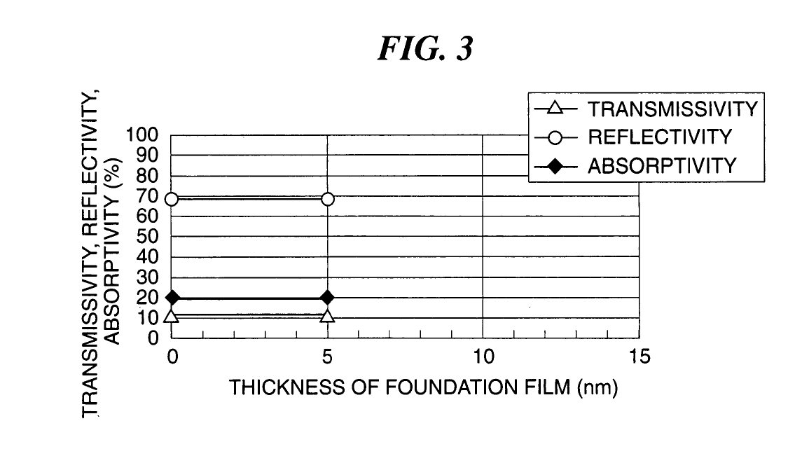

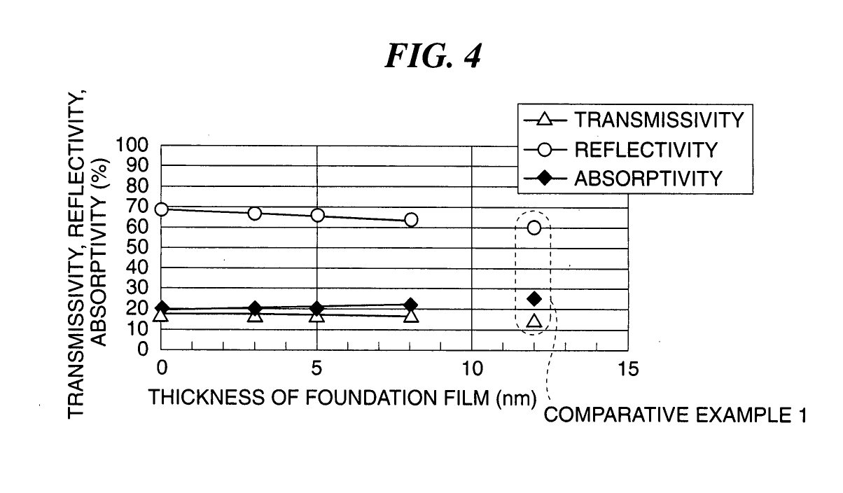

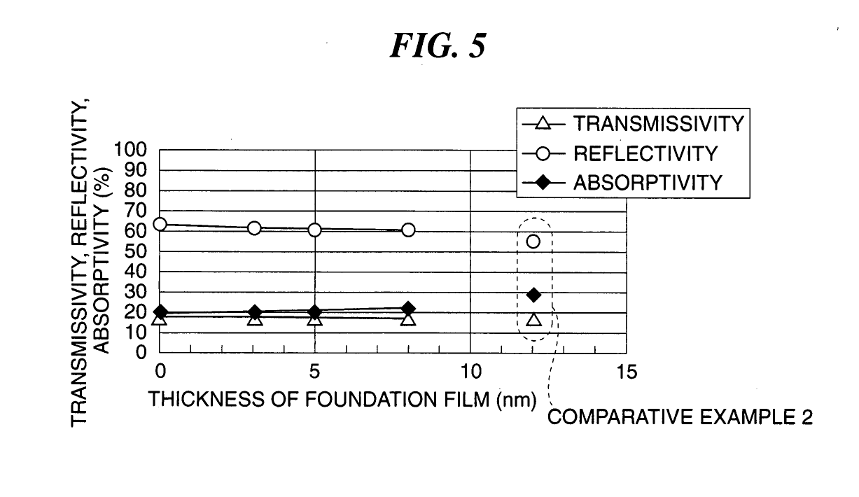

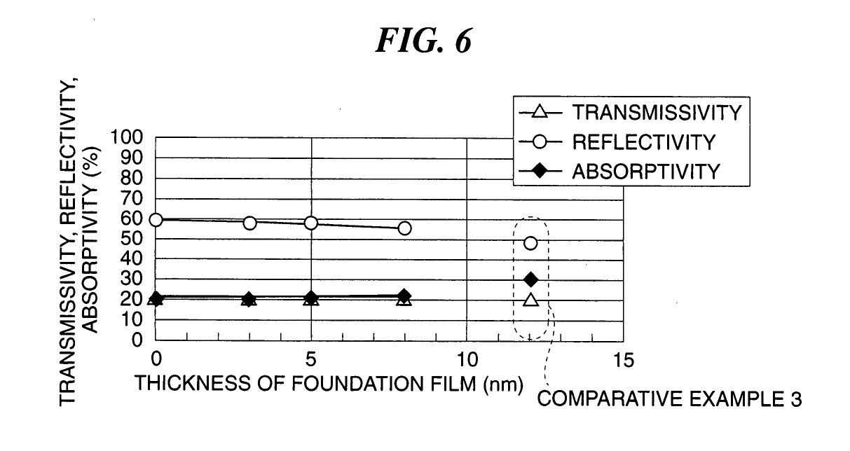

To evaluate the transmission performance and the reflection performance for each of the prepared samples, the optical properties, i.e. the transmissivity (%), the reflectivity (%), and the absorptivity (%), at a light wavelength λ of 550 nm were then measured using a spectrophotometer. The measurement results are shown in Table 1. In Table 1, the absorptivity (%) was calculated from the formula 100−(transmissivity (%)+reflectivity (%)). Moreover, the measurement results of Table 1 are shown in the form of graphs in FIGS. 3 to 6.

TABLE 1

| | | Thickness of Foundation | Thickness of | Thickness of | | | |
|---|---|---|---|---|---|---|---|
| | | Film (SiOₓ) | Reflective Film (Al) | Protective Film (SiO₂) | Transmissivity (%) | Reflectivity (%) | Absorptivity (%) |
| | | (nm) | (nm) | (nm) | [λ = 550 nm] | [λ = 550 nm] | [λ = 550 nm] |
| Examples | 1 | 0 | 13 | 25 | 12.4 | 68.2 | 19.4 |
| | 2 | 5 | 13 | 25 | 11.8 | 67.7 | 20.5 |
| | 3 | 0 | 11 | 25 | 15.2 | 66.9 | 17.9 |
| | 4 | 3 | 11 | 25 | 15.3 | 66.1 | 18.6 |
| | 5 | 5 | 11 | 25 | 14.9 | 65.6 | 19.5 |
| | 6 | 8 | 11 | 25 | 14.8 | 64.5 | 20.7 |
| | 7 | 0 | 9 | 25 | 17.9 | 62.9 | 19.2 |
| | 8 | 3 | 9 | 25 | 18.1 | 62.2 | 19.7 |
| | 9 | 5 | 9 | 25 | 18.3 | 61.2 | 20.5 |
| | 10 | 8 | 9 | 25 | 18.2 | 59.8 | 22.0 |
| | 11 | 0 | 7.5 | 25 | 20.7 | 58.1 | 21.2 |
| | 12 | 3 | 7.5 | 25 | 20.9 | 57.4 | 21.7 |
| | 13 | 5 | 7.5 | 25 | 20.9 | 56.8 | 22.3 |
| | 14 | 8 | 7.5 | 25 | 21.2 | 54.9 | 23.9 |
| Comparative | 1 | 12 | 11 | 25 | 15.1 | 59.8 | 25.1 |
| Examples | 2 | 12 | 9 | 25 | 17.8 | 53.8 | 28.4 |
| | 3 | 12 | 7.5 | 25 | 21.3 | 47.8 | 30.9 |

As shown in Table 1 and FIGS. 3 to 6, it was found that in the case that the transmissivity of the semi-transmitting mirror-possessing substrate 1 is unchanged, if the thickness of the foundation film 3 exceeds 8 nm, then the reflectivity suddenly drops. This drop in the reflectivity is due to an increase in the amount of optical absorption of the semi-transmitting mirror-possessing substrate 1. The higher the transmissivity of the semi-transmitting mirror-possessing substrate 1, i.e. the thinner the semi-transmitting reflective film 4, the more prominent the effect of the thickness of the foundation film 3 on the optical properties becomes. On the other hand, in the case that the transmissivity is low at 12%, the optical properties of the semi-transmitting mirror-possessing substrate 1 become constant, not depending on the thickness of the foundation film 3.

Next, the relationship between the chemical composition ratio x of oxygen (O) to silicon (Si) in the foundation film 3 (SiOₓ) and the optical properties was studied.

First, a foundation film 3 made of SiOₓ was formed on a glass substrate 2 by direct current sputtering as in the examples described above; here, the Ar/O₂ mixed gas flow rate ratio was changed, whereby samples (Examples 15 to 22) each comprised of a glass substrate 2 and a foundation film 3 were prepared as shown in Table 2.

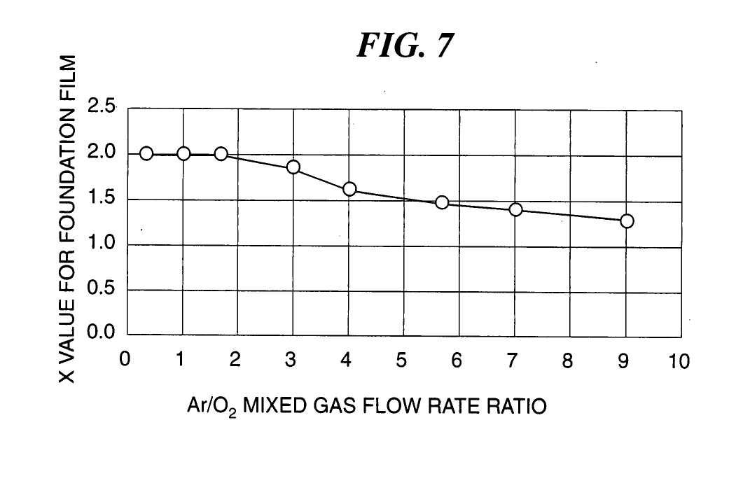

For each of the prepared samples, the chemical composition ratio x of oxygen (O) to silicon (Si) in the foundation film 3 (SiOₓ) was then measured using an electron spectroscopy method (ESCA: electron spectroscopy for chemical analysis), and moreover the thickness of the foundation film 3 (SiOₓ) was measured. The measurement results are shown in Table 2. Moreover, the measurement results of Table 2 are shown in the form of a graph in FIG. 7.

TABLE 2

| | | Foundation Film Sputtering Conditions | | | | | |
|---|---|---|---|---|---|---|---|
| | | Ar Gas Flow | O₂Gas Flow | Ar/O₂ Mixed | Sputtering | Thickness of | |
| | | Rate | Rate | Gas Flow Rate | Pressure | Foundation Film | x Value for |
| | | (sccm) | (sccm) | Ratio | (Pa) | (nm) | Foundation Film |
| Examples | 15 | 360 | 40 | 9.00 | 4.0 × 10⁻¹ | 28.9 | 1.3 |
| | 16 | 350 | 50 | 7.00 | 4.0 × 10⁻¹ | 29.3 | 1.4 |
| | 17 | 340 | 60 | 5.67 | 4.0 × 10⁻¹ | 29.2 | 1.45 |
| | 18 | 320 | 80 | 4.00 | 4.0 × 10⁻¹ | 30.4 | 1.6 |
| | 19 | 300 | 100 | 3.00 | 4.0 × 10⁻¹ | 31.0 | 1.85 |
| | 20 | 250 | 150 | 1.67 | 4.0 × 10⁻¹ | 32.3 | 2 |
| | 21 | 200 | 200 | 1.00 | 4.0 × 10⁻¹ | 32.1 | 2 |
| | 22 | 100 | 300 | 0.33 | 4.0 × 10⁻¹ | 33.2 | 2 |

As shown in Table 2 and FIG. 7, it was found that the chemical composition ratio x of oxygen (O) to silicon (Si) in the foundation film 3 (SiOₓ) formed by direct current sputtering changes in accordance with the Ar/O₂ gas flow rate ratio.

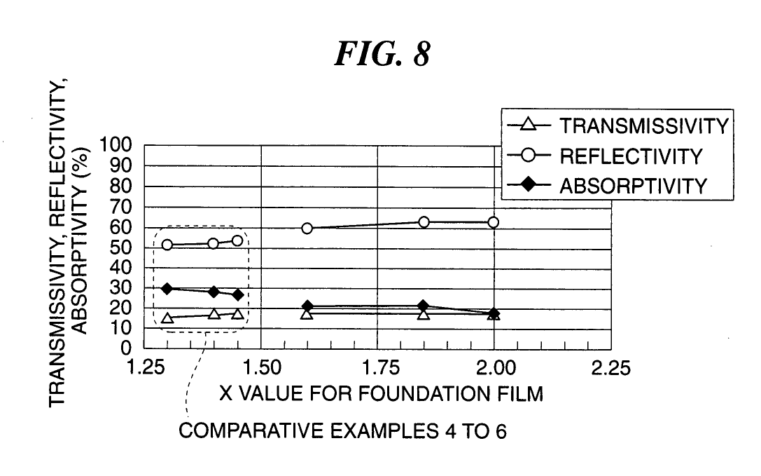

Next, a semi-transmitting reflective film 4 and a protective film 5 were formed on each of the samples (Examples 15 to 22) prepared in the above examples, thus preparing samples (Examples 23 to 27, and Comparative Examples 4 to 6) of semi-transmitting mirror-possessing substrates 1 as shown in Table 3, and then the optical properties of each of the samples were measured using a spectrophotometer. The measurement results are shown in Table 3. Incidentally, when forming the protective film 5, sputtering was carried out with the Ar/O₂ mixed gas flow rate ratio fixed at Ar:O₂=1:1. Moreover, the measurements results of Table 3 are shown in the form of a graph in FIG. 8.

TABLE 3

| | | Ar/O₂ Mixed | x Value for | | | |
|---|---|---|---|---|---|---|
| | | Gas Flow | Foundation | Transmissivity (%) | Reflectivity (%) | Absorptivity (%) |
| | | Rate Ratio | Film | [λ = 550 nm] | [λ = 550 nm] | [λ = 550 nm] |
| Examples | 23 | 4.00 | 1.6 | 18.5 | 60.1 | 21.4 |
| | 24 | 3.00 | 1.85 | 18.4 | 61.9 | 19.7 |
| | 25 | 1.67 | 2 | 18.7 | 62.3 | 19.0 |
| | 26 | 1.00 | 2 | 18.5 | 63.1 | 18.4 |
| | 27 | 0.33 | 2 | 18.5 | 62.8 | 18.7 |
| Comparative | 4 | 9.00 | 1.3 | 17.6 | 52.3 | 30.1 |
| Examples | 5 | 7.00 | 1.4 | 18.1 | 53.1 | 28.8 |
| | 6 | 5.67 | 1.45 | 18.3 | 54.2 | 27.5 |

As shown in Table 3 and FIG. 8, it was found that in the case that the transmissivity of the semi-transmitting mirror-possessing substrate 1 is unchanged, if the chemical composition ratio x of oxygen (O) to silicon (Si) in the foundation film 3 (SiOₓ) is less than 1.5, then the reflectivity drops suddenly (Comparative Examples 4 to 6). This drop in the reflectivity is due to an increase in the amount of optical absorption of the semi-transmitting mirror-possessing substrate 1. In other words, it was found that the chemical composition ratio x of oxygen (O) to silicon (Si) in the foundation film 3 (SiOₓ) being in a range of 1.5 to 2.0 is effective for obtaining high reflectivity with the semi-transmitting mirror-possessing substrate 1.

Industrial Applicability

As described in detail above, according to the semi-transmitting mirror-possessing substrate according to the first aspect of the present invention, the foundation film has a thickness in a range of 0 to 8 nm; as a result, the reflectivity can be increased while maintaining high transmissivity, and hence both the transmission performance and the reflection performance can be improved.

Moreover, in the semi-transmitting mirror-possessing substrate according to the first aspect, if the foundation film is made of silicon oxide, then the semi-transmitting reflective film can be protected from impurities leaching out from the inside of the substrate.

Moreover, in the semi-transmitting mirror-possessing substrate according to the first aspect, if the chemical composition ratio x of oxygen (O) to silicon (Si) in the silicon oxide (SiOₓ) is made to be in a range of 1.5 to 2.0, then the reflectivity can be increased while maintaining high transmissivity, and hence both the transmission performance and the reflection performance can be improved.

Furthermore, in the semi-transmitting mirror-possessing substrate according to the first aspect, if the semi-transmitting reflective film is made of Al or an Al alloy, then the reflectivity can be increased while maintaining high transmissivity.

According to the semi-transmitting type liquid crystal display apparatus according to the second aspect of the present invention, the semi-transmitting type liquid crystal display apparatus has the semi-transmitting mirror-possessing substrate according to the first aspect of the present invention; as a result, there is high reflectivity while maintaining high transmissivity, and hence a semi-transmitting type liquid crystal display apparatus having both improved transmission display performance and improved reflection display performance can be obtained.

1. A semi-transmitting mirror-possessing substrate having a glass substrate, a foundation film formed on said glass substrate, and a semi-transmitting reflective film formed on said foundation film, the semi-transmitting mirror-possessing substrate characterized in that said foundation film is made to have a thickness in a range of 0 to 8 nm.

2. A semi-transmitting mirror-possessing substrate as claimed in claim 1, characterized in that said foundation film is made of silicon oxide.

3. A semi-transmitting mirror-possessing substrate as claimed in claim 2, characterized in that a chemical composition ratio x of oxygen (O) to silicon (Si) in the silicon oxide (SiOₓ) is in a range of 1.5 to 2.0.

4. A semi-transmitting mirror-possessing substrate as claimed in claim 1, characterized in that said semi-transmitting reflective film is made of at least one selected from the group consisting of Al and Al alloys.

5. A semi-transmitting type liquid crystal display apparatus, characterized by having a semi-transmitting mirror-possessing substrate as claimed in claim 1.

6. A semi-transmitting mirror-possessing substrate having a glass substrate, a foundation film formed on said glass substrate, and a semi-transmitting reflective film formed on said foundation film, the semi-transmitting mirror-possessing substrate characterized in that said foundation film is made of silicon oxide having a thickness in a range of 0 to 8 nm, a chemical composition ratio x of oxygen (O) to silicon (Si) in the silicon oxide (SiOₓ) is in a range of 1.5 to 2.0, and said semi-transmitting reflective film is made of at least one selected from the group consisting of Al and Al alloys.

7. A semi-transmitting type liquid crystal display apparatus, characterized by having a semi-transmitting mirror-possessing substrate as claimed in claim 6.
